(19) United States
(12) Patent Application Publication
(10) Pub. No.: US 2006/0284511 A1
(43) Pub. Date: Dec. 21, 2006

(54) Enhanced electrical machine cooling

(76) Inventors: Steve T. Evon, Easley, SC (US); William E. Martin, Greenville, SC (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 11/158,952

(22) Filed: Jun. 21, 2005

(51) Int. Cl. H02K 9/00; H02K 3/24

(52) U.S. Cl. 310/216; 310/64; 310/58

(57) ABSTRACT

In one embodiment, the present technique relates to a motor having enhanced cooling. The exemplary motor includes a stator core that is formed of a plurality of stator laminations and that is, at least partially, a peripheral surface of the motor. Each stator lamination has a plurality of fins that extend radially outward. When assembled, the fins of adjacent laminations cooperate to form larger fins extending the length of the stator core. These fins enhance the cooling of the motor, by improving heat dissipation of the motor.

### BACKGROUND

The present technique relates generally to the field of electrical machines, which includes electrical motors and generators. More particularly, the present technique relates to the dissipation of heat in such electrical machines.

Electrical machines, such a motors and generators, are commonly found in industrial, commercial, and consumer settings. In industry, such machines are employed to drive various kinds of devices, including pumps, conveyors, compressors, fans, and so forth, to mention only a few. In the case of electric motors and generators, these devices generally include a stator, comprising a multiplicity of stator windings, surrounding a rotor.

By establishing an electromagnetic relationship between the rotor and the stator, electrical energy can be converted into kinetic energy, and vice-versa. In the case of alternating current (ac) motors, ac power applied to the stator windings effectuates rotation of the rotor. The speed of this rotation is typically a function of the frequency of the ac input power (i.e., frequency) and of the motor design (i.e., the number of poles defined by the stator windings). Advantageously, a rotor shaft extending through the motor housing takes advantage of this produced rotation, translating the rotor's movement into a driving force for a given piece of machinery. Conversely, in the case of an ac generator, rotation of an appropriately magnetized rotor induces current within the stator windings, in turn producing electrical power.

During operation, conventional motors and generators produce heat. The physical interaction of the machine's various moving components may produce heat by way of friction, and electrical current passing through the windings in the stator and rotor produce heat by way of resistive and inductive heating, for example. If left unabated, excess heat may degrade the performance of the machine, reducing efficiency, for instance. Worst yet, excess heat may contribute to any number of malfunctions, leading to system down time and, in certain instances, requiring maintenance and/or replacement. Undeniably, reduced efficiency and increased malfunctions are undesirable events that may lead to increased costs.

Unfortunately, traditional electrical motors and generators—particularly Totally Enclosed Fan Cooled (TEFC) assemblies—house the stator core within a frame assembly, placing an intermediate structure between the stator core and the surrounding environment and, thus, decreasing the efficacy of applied convective cooling techniques. For instance, cooling airflow produced by a fan does not come into contact with the outer peripheral surface of the stator core, but instead travels over the surrounding frame assembly. Because it is an intermediate structure, this frame retards the efficacy of the cooling airflow with respect to the stator core.

There is a need, therefore, for improved techniques for cooling electrical machines, such as motors and generators.

### BRIEF DESCRIPTION

In accordance with certain exemplary embodiments, the present technique provides an electrical machine that has enhanced cooling features. The exemplary electrical machine includes a plurality of stator laminations, each stator lamination having a plurality of fins extending radially outward with respect to the stator lamination. When assembled in an electrical machine, the plurality of stator laminations cooperates to define a stator core. Cooling airflow generated by a fan, for example, is routed over the outer peripheral surface of the stator core: The stator fins improving heat dissipation in the electrical machine.

As an exemplary embodiment, the present technique also provides a stator lamination having a plurality of protrusions that at least partially define the outer periphery of the stator lamination. The protrusions increase the length of the outer periphery than if the stator lamination were generally circular or polygonal in shape. Advantageously, this increased length translates into an increased surface area for the outer surface of a stator core that employs the exemplary stator laminations, in turn improving the efficacy of convective cooling of the stator core.

### DRAWINGS

The foregoing and other advantages and other features of the present technique will become apparent upon reading the following detailed description and upon reference to the drawings in which:

FIG. 1 is a perspective view of an electrical machine, in accordance with an embodiment of the present technique;

FIG. 2 is a partial cross-sectional view of the electrical machine of FIG. 1, the partial cross-section taken along line 2-2;

FIG. 3 is a perspective view of a stator core assembly, in accordance with an embodiment of the present technique; and

FIG. 4 is an exploded perspective view of a series of adjacent stator laminations, in accordance with embodiment of the present technique.

### DETAILED DESCRIPTION

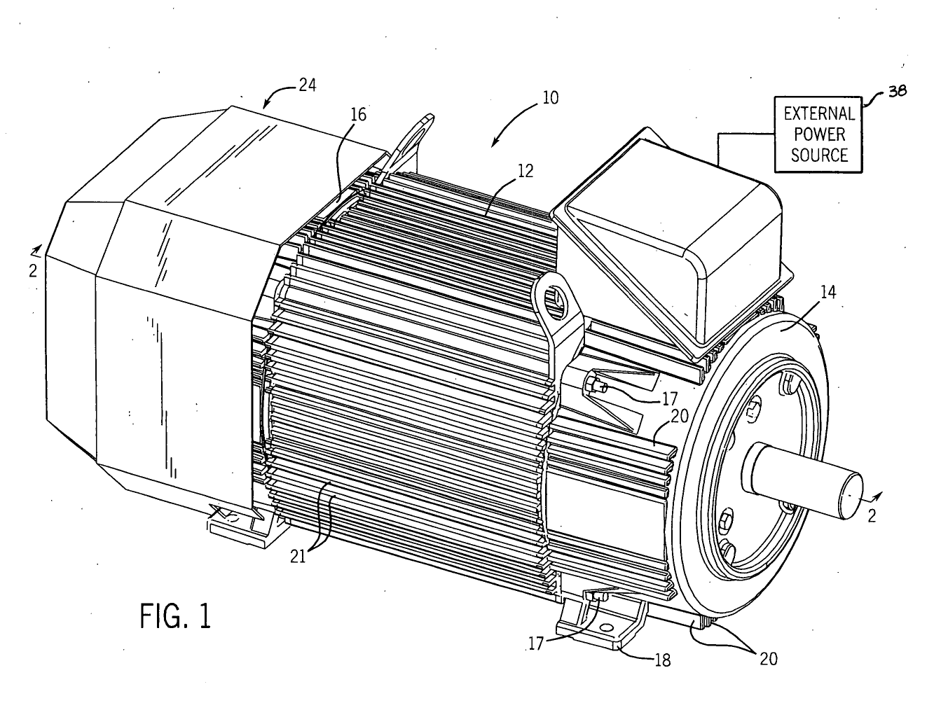

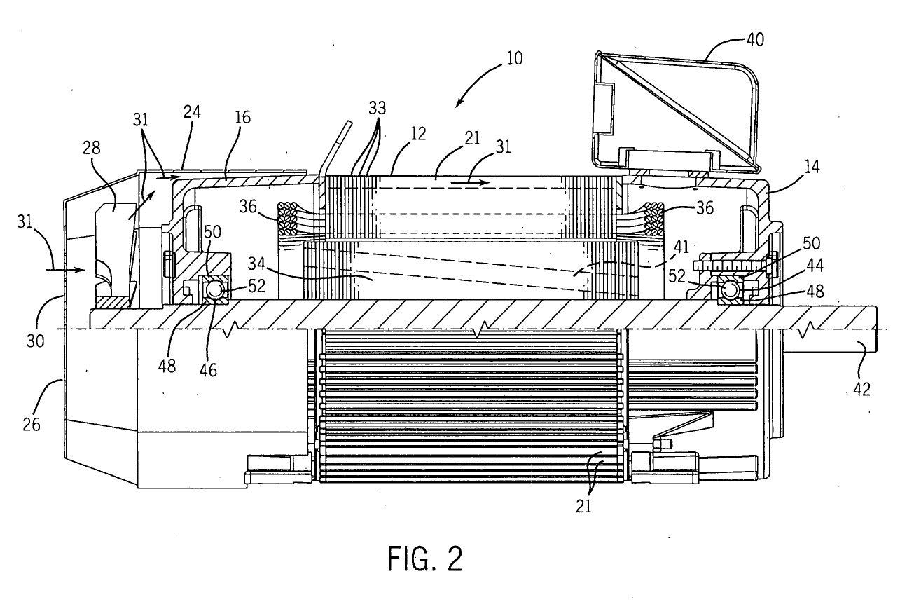

Turning the figures, FIGS. 1 and 2 illustrate an exemplary electrical machine 10. As illustrated, the exemplary electrical machine 10 is envisaged as an induction motor. However, it is worth noting that the present technique is applicable to any number of electrical machines, including electrical motors and electrical generators. Moreover, although the following discussion focuses on induction devices, the present technique is equally applicable to direct current (dc) devices as well as permanent magnet (pm) devices. For example, devices in which the rotor's magnetic flux is produced as a result of the material employed—and not by induction—also benefit from the present technique.

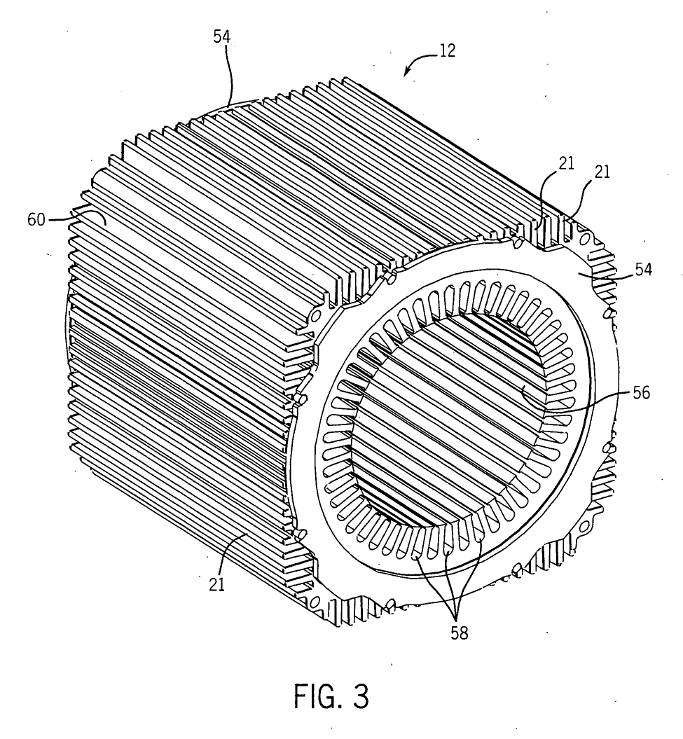

The exemplary machine 10 includes a stator core 12 capped at opposite ends by drive-end and opposite drive-end endcaps 14 and 16, respectively. Advantageously, the exemplary endcaps 14 and 16 include mounting and transportation features, such as the mounting flanges 18, as well as heat dissipation features, such as the endcap cooling fins 20. The stator core 12, which defines the central, peripheral portions of the machine 10, also includes protruding stator cooling fins 21 (see also FIG. 3) to improve heat dissipation. The endcaps 14 and 16 and the stator core 12 are maintained in assembly by through-bolts 17 extending axially through the endcaps 14 and 16 and the stator core 12.

The tight fit and close tolerances between the assembled stator core 12 and endcaps 14 and 16 prevent the ingress of containments into the interior of the machine 10. Specifically, the exemplary machine 10 presents a Totally Enclosed Fan Cooled (TEFC) construction, as is defined by the National Electrical Manufactures Association (NEMA) and as is appreciated by those of ordinary skill in the art. In other words, the exemplary endcaps 14 and 16 and stator core 12 cooperate to present a assembly that is resistant to, but not sealed from the ingress of contaminants. It is worth noting, however, that those skilled in the art will appreciate in view of this discussion that a wide variety of motor and generator configurations may employ the cooling techniques outlined herein, and the present technique is not limited to TEFC's.

To effectuate cooling, the exemplary machine 10 includes a cooling assembly 24 disposed on the opposite drive-end of the machine 10. This cooling assembly 24 includes a shroud 26 mounted to the opposite drive-end endcap 16 and a fan 28. The shroud 26 directs air drawn in through vents 30 toward the drive end of the machine 10, thus directing airflow over the peripheral surfaces of the stator core 12 and endcaps 14 and 16, to cool the machine 10. It is worth noting, however, the cooling may be effectuated by an independent blower unit as well as by ambient air traveling over the peripheral surfaces of the stator core 12, particularly the cooling fins 21.

As is best illustrated in FIG. 2, the stator core 12 comprises a plurality of stator laminations 33 aligned and assembled with respect to one another to form the contiguous stator core 12. Moreover, this figure also well illustrates that the stator core 12 at least partially defines an external surface (i.e., peripheral) surface of the machine 10. Thus, as is discussed further below, the fan 28 directs airflow over the stator core's 12 cooling fins 21, as is represented by directional arrows 31. As is also discussed further below, routing airflow directly over the outer peripheral surfaces of the stator core 12 without any intermediate structure, such as a frame, improves the efficacy of cooling techniques for dissipating heat generated in the machine 10 during operation.

To induce rotation of a rotor 34 located in the stator core 12 if the machine 10 is acting as an electric motor—alternating current is routed through windings 36 disposed in the stator core 12. The stator windings 36, of which only the end turns are shown in FIG. 2, are electrically interconnected to form groups that are, in turn, interconnected in a manner generally known in the pertinent art. These stator windings 36 are further coupled to terminal leads (not shown) that electrically connect the stator windings to an external power source 38, such as a 480 Vac three-phrase power source or a 110 Vac single-phase power source, to name but a few types. The electrical connection between the terminal leads and the external power source 38 is housed in a conduit box 40. The conduit box 40 may be formed of metal or plastic and, advantageously, provides access to certain electrical components of the machine 10, for repair and maintenance, for instance.

Routing electrical current from external power source 38 through the stator windings 36 creates electromagnetic relationships with the rotor 34 (particularly with the conductor bars 41 extending axially through the rotor 34) that cause rotation of the rotor 34, as is appreciated by those of ordinary skill in the art. A rotor shaft 42 coupled to the rotor 34 also rotates in response to rotation of the rotor 34. Through the rotor shaft 42, torque may be transmitted to any number of drive machine elements. Rotation of the fan 28 is also driven.

Rotation of the rotor 34 within the electrical device is facilitated by drive-end and opposite drive-end bearing assemblies 44 and 46, respectively. Each bearing assembly 44 and 46 includes an inner race 48 that circumscribes the rotor shaft 42, an outer race 50 in abutment with the corresponding endcap 14 or 16, and a ball bearing 52 disposed between the inner the outer races. When seated in its appropriate endcap, the inner race 48 of each bearing assembly rotates in conjunction with the rotor while the outer race 50 remains stationary and seated. Advantageously, a lubricant disposed about the ball bearing 52 reduces friction within the bearing assemblies 44 and 46 and improves operation of the electrical machine 10.

Turning to FIG. 3, this figure illustrates an exemplary stator core 12. The stator core 12, as discussed above, includes a plurality of laminations 33 assembled and aligned with respect to one another. The exemplary stator core 12 also includes end rings 54 disposed on opposite ends of the stator core 12. These end rings 54 facilitate assembly of the stator laminations 33 with respect to one another and, further, facilitate assembly of the stator core 12 with respect to the endcaps 14 and 16 (see FIG. 1).

When assembled, the stator laminations 33 cooperate to present a number of features and attributes. For example, the stator laminations 33 cooperate to define a central chamber 56 that extends axially thought the stator core 12 and in which the rotor 34 (see FIG. 2) resides. These laminations 33 also cooperate to define slots 58 that extend axially through the stator core and that are configured to support the stator windings 36 (see FIG. 2). Further still, the outer peripheries of the laminations 33 cooperate to form the outer peripheral surfaces 60 of the stator core 12, which is also an outer peripheral surface of the machine 10. For example, the stator fins 21 of adjacent lamination cooperate to form the cumulative stator fin that extends the length of the stator core 12.

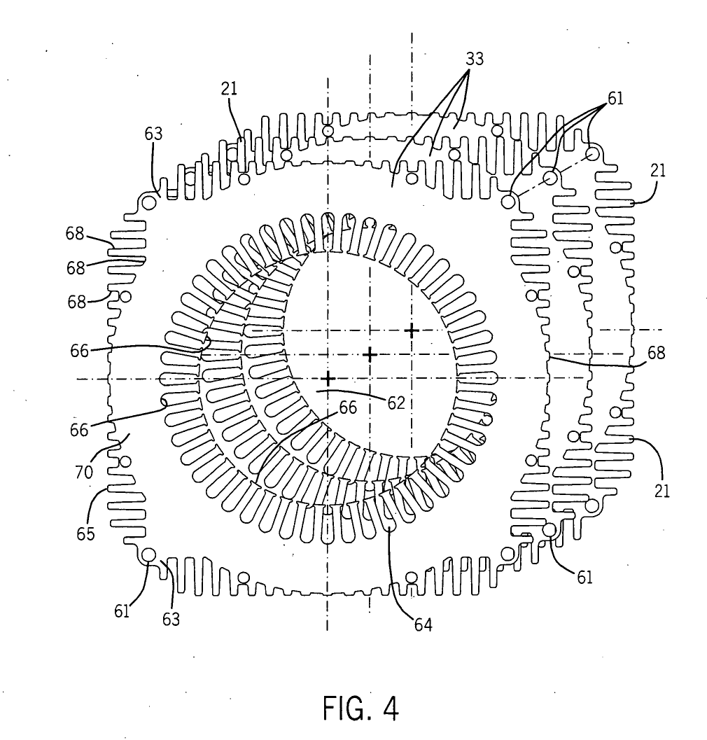

Turing to FIG. 4, this figure illustrates a series of adjacent stator laminations 33 exploded with respect to one another. As illustrated the exemplary stator lamination 33 has a generally square outline, with the lamination's radially outmost edges 65 generally defining a rectangular shape. Such stator laminations 33 can be fabricated via a stamping process, in which a material blank is stamped to produce the desired shape.

Each stator lamination 33 includes a through-bolt receiving aperture 61 located on a stem portion 63 of the stator lamination 33. Advantageously, it is believed that placing this receiving aperture 61 on the stem portion 63 improves the structural integrity of the assembled stator core 12. Each stator lamination also includes a central aperture 62 sized to receive a rotor 34 (see FIG. 2). Disposed about this aperture 62 are a series of slots 64, each configured to receive an incremental portion of a stator winding 36 (see FIG. 2). The slots 64 and the central aperture 62 essentially define the inner periphery 66 of the stator lamination 33. The outer periphery 68 of the stator lamination 33 is defined by each lamination's 33 stator fins 21, which each extend radially outward with respect to the stator lamination 33, and the body portion 70, which extends between the stator fins 21. The stator fins 21 increase the length of the outer periphery 68 in comparison to a similar stator lamination in which the lamination had a generally circular or polygonal shape. For example, if a lamination were ring-like, the outer periphery of such lamination would simply be the lamination's mathematical circumference. However, through the inclusion of the protruding stator fins 21, the length of the outer periphery 68 is increased, as the outer periphery now includes the periphery of each stator fin 31. Increasing the outer periphery's 68 length increases the overall surface area of the outer peripheral surface 60 of the assembled stator core 12, increasing the surface area over which cooling airflow travels. Advantageous, increasing the surface area over which airflow travels improves heat dissipation in the machine 10. In turn, the efficiency of the machine 10 can be improved by allowing for a reduction in the amount of active material; more specifically a reduction in the ratio of the active material per horse power employed in the machine's construction.

By way of example, in a 60 hp TEFC motor assembly with a stator lamination stack (i.e., stator core) length of 12 in., it is believed that that winding temperature rise can be reduced by 17.1° C. in comparison to a traditional assembly having a stator core disposed within a frame. For a 75 hp TEFC motor assembly with the same 12 in. lamination stack length, it is believed that a 17.2° C. reduction in temperature can be obtained. The following table summarizes believed improvements obtained through the present exemplary embodiment.

TABLE 1

| | TEFC Enclosure | | | |
|---|---|---|---|---|
| | Existing Frame | | New Finned Frame | |
| Rating | 60 Hp | 75 Hp | 60 Hp | 75 Hp |
| Lamination Stack Length | 12.0 in | 12.0 in | 12.0 in | 12.0 in |
| Motor Losses | 2.916 kW | 3.895 kW | 2.916 kW | 3.895 kW |
| Motor Efficiency | 93.9% | 93.5% | 93.9% | 93.5% |
| Winding Temperature | 94.6° C. | 128.7° C. | 77.5° C. | 111.5° C. |
| Rise | | | | |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A stator lamination for an electrical machine, comprising:
a central aperture sized to receive a rotor;
a plurality of stator slots disposed about the central aperture and configured to receive a plurality of stator windings; and
a plurality of fins extending radially outward with respect to the stator lamination, the plurality of fins at least partially defining an outer periphery of the stator lamination.

2. The stator lamination as recited in claim 1, wherein radially outermost edges of the stator lamination define a generally polygonal outline.

3. The stator lamination as recited in claim 2, wherein adjacent fins on a side of the stator lamination are generally parallel to one another

4. The stator lamination as recited in claim 1, wherein the stator lamination, excluding the plurality of fins, has a generally circular cross-section defined by the outer periphery of the stator lamination.

5. The stator lamination as recited in claim 1, wherein the plurality of fins substantially surrounds the annular body.

6. An electrical machine, comprising:
a stator core comprising a central chamber and a plurality of stator laminations, each stator lamination having a plurality of fins extending radially outward with respect to the stator lamination;
a plurality of electrical conductors extending axially through the stator core;
a rotor disposed in the central chamber;
first and second endcaps disposed at opposite ends of the stator core; and
a cooling mechanism configured to produce airflow over an outer peripheral surface of the stator core.

7. The electrical machine as recited in claim 6, wherein the cooling mechanism is mechanically coupled to the rotor.

8. The electrical machine as recited in claim 6, wherein the electrical machine is a Totally Enclosed Fan Cooled (TEFC) assembly.

9. The electrical machine as recited in claim 6, wherein the electrical machine is configured for use as a generator.

10. The electrical machine as recited in claim 6, comprising a shroud coupled to the first endcap and configured to direct airflow toward the outer peripheral surface of the stator core.

11. The electrical machine as recited in claim 6, wherein the stator core, excluding the plurality of fins, has a generally cylindrical shape.

12. The electrical machine as recited in claim 6, the stator core having adjacent fins that are generally parallel to one another.

13. The electrical machine as recited in claim 6, wherein the rotor includes a permanent magnet material.

14. An electrical machine, comprising:
a stator core comprising a plurality of stator laminations, each stator lamination being cooperative with adjacent stator laminations to define a central chamber extending axially through the stator core, a plurality of slots disposed about the central chamber and extending axially through the stator core, and a plurality of fins extending radially outward with respect to the stator core, wherein the stator core at least partially defines an outer peripheral surface of the electrical machine;
a plurality of windings disposed in the plurality of slots;
a rotor disposed in the central chamber; and
first and second endcaps disposed at opposite ends of the stator core.

15. The electrical machine as recited in claim 14, comprising a fan configured to produce airflow over the outer peripheral surface of the stator core.

16. The electrical machine as recited in claim 15, wherein the fan is disposed on a rotor shaft of the rotor.

17. The electrical machine as recited in claim 14, wherein the electrical machine is a Totally Enclosed Fan Cooled (TEFC) assembly.

18. The electrical machine as recited in claim 14, wherein fins of the plurality of fins are generally parallel to one another.

19. The electrical machine as recited in claim 14, wherein the rotor comprises a permanent magnetic material.

20. A method for manufacturing a stator of an electrical machine, comprising:
forming a stator lamination having a plurality of fins extending radially outward with respect to the stator lamination and at least partially defining a outer periphery of the stator lamination, a central aperture sized to receive a rotor, and a plurality of slots disposed about the central aperture and configured to receive windings.

21. The method as recited in claim 20, comprising assembling the laminations with respect to one another such that adjacent laminations cooperate to define a central chamber configured to receive a rotor.

22. The method as recited in claim 20, wherein forming comprising stamping the lamination from a material blank.

23. A method of cooling an electrical machine having a stator core, comprising:
routing airflow over a plurality of fins extending radially outward from the stator core and at least partially defining the outer peripheral surface of the stator core.

24. A stator lamination for an electrical machine, comprising:
a central aperture sized to receive a rotor;
a plurality of slots disposed about the central aperture and configured to receive windings;
a outer periphery defining a cross-section of the stator lamination; and
a plurality of protrusions extending radially outward with respect to the stator lamination and at least partially defining the outer periphery, the plurality of protrusions increasing the length of the outer periphery of the lamination than if the stator lamination were generally circular or polygonal in shape.

25. The stator lamination as recited in claim 24, wherein the plurality of protrusions increase the length of the outer periphery by at least ten percent than if the stator lamination were generally circular or polygonal in shape.
